(19) United States
(12) Patent Application Publication
(10) Pub. No.: US 2023/0105976 A1
(43) Pub. Date: Apr. 6, 2023

(54) TEMPERATURE-ADAPTIVE BATTERY CHARGING

(71) Applicant: Apple Inc., Cupertino, CA (US)

(72) Inventors: Akshaya PADHI, Sunnyvale, CA (US); Sang Young YOON, San Jose, CA (US); Qingzhi GUO, Brookfield, WI (US); Ryan BALLIET, Palo Alto, CA (US)

(73) Assignee: Apple Inc., Cupertino, CA (US)

(21) Appl. No.: 17/478,693

(22) Filed: Sep. 17, 2021

(51) Int. Cl. H02J 7/00

(52) U.S. Cl. CPC H02J 7/007194; H02J 7/00309; H02J 7/007182

(57) ABSTRACT

Exemplary temperature-adaptive battery charging systems can discontinue, or disable, charging of the rechargeable battery in accordance with various C rates, such as the C/40 rate, the C/20 rate, and/or the C/15 rate to provide some examples, in response to the temperature of the rechargeable battery. In some embodiments, the exemplary temperature-adaptive battery charging systems can discontinue, or disable, charging of the rechargeable battery in accordance a first C rate, such as the C/40 rate to provide an example, when the temperature of the rechargeable battery is within a first temperature range. The exemplary temperature-adaptive battery charging systems can dynamically adapt the discontinuing, or cutting off, of the charging of the rechargeable battery in response to the temperature of the rechargeable battery increasing and/or decreasing as the rechargeable battery being charged. The exemplary temperature-adaptive battery charging systems can dynamically adapt the discontinuing, or cutting off, of the charging of the rechargeable battery from being in accordance with the first C rate to be in accordance with a second C rate, such as the C/20 rate or the C/15 rate to provide some examples, when the temperature of the rechargeable battery increases from the first temperature range to a second temperature range.

### BACKGROUND

Advances in technology and engineering have allowed designers and manufacturers to offer more portable electronic devices to consumers. These portable electronic devices range from mobile computing devices, also referred to as handheld computers, to mobile communication devices. At the heart of the portable electronic devices lies one or more batteries to provide necessary power for operation. The one or more batteries store energy in a chemical form and convert the stored chemical energy into electrical energy via electrochemical reactions. Generally, each of the one or more batteries include two electrodes separated by an electrically insulating and ionically conducting electrolyte and optionally an electrically insulating separator. During operation of the portable electronic devices, a first chemical reaction within a first electrode, called the anode, generates electrons and a second chemical reaction within a second electrode, called the cathode, receives these electrons. This flow of electrons from the anode to the cathode discharges electrical energy from the one or more batteries for operation of the portable electronic devices. The one or more batteries continue to provide this electrical energy until the anode and/or the cathode can no longer perform their respective chemical reactions. Conventionally, the designers and the manufacturers of the portable electronic devices often use rechargeable batteries for the one or more batteries of the portable electronic devices. The chemical energy of rechargeable battery can be restored by applying electrical energy from an outside source to the rechargeable battery. This outside source supplies electrons to the anode and removes electrons from the cathode which forces their respective chemical reactions into reverse to replenish the stored chemical energy within the rechargeable battery.

### SUMMARY OF DISCLOSURE

Some embodiments of this disclosure describe a temperature-adaptive rechargeable battery system for charging a rechargeable battery. The temperature-adaptive rechargeable battery system includes a battery charger and processing circuitry. The battery charger provides a charging current to charge the rechargeable battery. The processing circuitry monitors a temperature of the rechargeable battery, determines a temperature dependent C rate for charging the rechargeable battery based upon the temperature of the rechargeable battery, and causes the battery charger to disable the charging current in response to the charging current reaching the selected temperature dependent C rate.

In some embodiments, the processing circuitry can select a first temperature dependent C rate from among the multiple temperature dependent C rates as the temperature dependent C rate in response to temperature of the rechargeable battery being within a first temperature range, a second temperature dependent C rate from among the multiple temperature dependent C rates as the temperature dependent C rate in response to temperature of the rechargeable battery being within a second temperature range, and a third temperature dependent C rate from among the multiple temperature dependent C rates as the temperature dependent C rate in response to temperature of the rechargeable battery being within a third temperature range. In these embodiments, the first temperature dependent C rate can include a C/40 rate, the second temperature dependent C rate can include a C/20 rate, and the third temperature dependent C rate can include a C/15 rate. In these embodiments, the first temperature range can include temperatures less than thirty (30) degrees Celsius, the second temperature range can include temperatures between thirty (30) degrees Celsius and thirty-seven (37) degrees Celsius, and the third temperature range can include temperatures greater than thirty-seven (37) degrees Celsius.

In some embodiments, the processing circuitry can determine the temperature dependent C rate from:

$$\frac{C}{{x}^{′}}$$

wherein C represents a 1.0C rate and x represents a mathematical function, for example, f(T), having the temperature (T) of rechargeable battery as the argument of the mathematical function.

In some embodiments, the battery charger can vary a voltage at the rechargeable battery to maintain a constant current flow from the charging current in a constant current (CC) charging operation, and vary the constant current flow toward the selected temperature dependent C rate to maintain the voltage at the rechargeable battery in a constant voltage (CV) charging operation. In these embodiments, the processing circuitry can monitor the voltage at the rechargeable battery and cause the battery charger to switch from the CC charging operation to the CV charging operation in response to the voltage reaching a pre-determined battery voltage.

Some embodiments of this disclosure describe a method for reducing an exposure time of a rechargeable battery to slow a degradation of the rechargeable battery. The method includes monitoring a temperature of the rechargeable battery as the rechargeable battery is being charged by a charging current, selecting a temperature dependent C rate from among multiple temperature dependent C rates in response to the temperature of the rechargeable battery, and cutting off charging of the rechargeable battery in response to the charging current reaching the selected temperature dependent C rate to reducing the exposure time of the rechargeable battery to slow the degradation of the rechargeable battery.

In some embodiments, the selecting can include selecting a first temperature dependent C rate from among the multiple temperature dependent C rates as the temperature dependent C rate in response to temperature of the rechargeable battery being within a first temperature range, a second temperature dependent C rate from among the multiple temperature dependent C rates as the temperature dependent C rate in response to temperature of the rechargeable battery being within a second temperature range, and a third temperature dependent C rate from among the multiple temperature dependent C rates as the temperature dependent C rate in response to temperature of the rechargeable battery being within a third temperature range. In these embodiments, the first temperature dependent C rate can include a C/40 rate, the second temperature dependent C rate can include a C/20 rate, and the third temperature dependent C rate can include a C/15 rate. In these embodiments, the first temperature range can include temperatures less than thirty (30) degrees Celsius, the second temperature range can include temperatures between thirty (30) degrees Celsius and thirty-seven (37) degrees Celsius, and the third temperature range can include temperatures greater than thirty-seven (37) degrees Celsius.

In some embodiments, the method can further include causing a voltage at the rechargeable battery to be varied to maintain a constant current flow from the charging current in a constant current (CC) charging operation and causing the constant current flow to be varied toward the selected temperature dependent C rate to maintain the voltage at the rechargeable battery in a constant voltage (CV) charging operation. In these embodiments, the method can further include monitoring the voltage at the rechargeable battery and switching from the CC charging operation to the CV charging operation in response to the voltage reaching a pre-determined battery voltage. In these embodiments, the pre-determined battery voltage can include a maximum battery voltage.

Some embodiments of this disclosure describe a portable electronic device. The portable electronic device can include a temperature-adaptive rechargeable battery system and a host processor. The temperature-adaptive rechargeable battery system provides a charging current to charge the rechargeable battery. The host processor monitors a temperature of the rechargeable battery, determines a temperature dependent C rate in response to the temperature of the rechargeable battery, and causes the temperature-adaptive rechargeable battery system to disable the charging current in response to the charging current reaching the selected temperature dependent C rate.

In some embodiments, the host processor can select a first temperature dependent C rate from among the multiple temperature dependent C rates as the temperature dependent C rate in response to temperature of the rechargeable battery being within a first temperature range, a second temperature dependent C rate from among the multiple temperature dependent C rates as the temperature dependent C rate in response to temperature of the rechargeable battery being within a second temperature range, and a third temperature dependent C rate from among the multiple temperature dependent C rates as the temperature dependent C rate in response to temperature of the rechargeable battery being within a third temperature range. In these embodiments, the first temperature dependent C rate can include a C/40 rate, the second temperature dependent C rate can include a C/20 rate, and the third temperature dependent C rate can include a C/15 rate. In these embodiments, the first temperature range can include temperatures less than thirty (30) degrees Celsius, the second temperature range can include temperatures between thirty (30) degrees Celsius and thirty-seven (37) degrees Celsius, and the third temperature range can include temperatures greater than thirty-seven (37) degrees Celsius.

In some embodiments, the host processor can determine the temperature dependent C rate from:

$$\frac{C}{{x}^{′}}$$

wherein C represents a 1.0C rate and x represents a mathematical function, for example, f(T), having the temperature (T) of rechargeable battery as the argument of the mathematical function.

In some embodiments, the temperature-adaptive rechargeable battery system can vary a voltage at the rechargeable battery to maintain a constant current flow from the charging current in a constant current (CC) charging operation, and vary the constant current flow toward the selected temperature dependent C rate to maintain the voltage at the rechargeable battery in a constant voltage (CV) charging operation. In these embodiments, the host processor can monitor the voltage at the rechargeable battery and cause the temperature-adaptive rechargeable battery system to switch from the CC charging operation to the CV charging operation in response to the voltage reaching a pre-determined battery voltage. In these embodiments, the pre-determined battery voltage can include a maximum battery voltage.

This Summary is provided merely for purposes of illustrating some embodiments to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the disclosure and, together with the description, further serve to explain the principles of the disclosure and enable a person of skill in the relevant art(s) to make and use the disclosure.

FIG. 1 graphically illustrates a simplified block diagram of a portable electronic device in accordance with various embodiments.

FIG. 2A and FIG. 2B graphically illustrate exemplary temperature adaptive charging protocols to charge an exemplary rechargeable battery in accordance with various embodiments.

FIG. 3 graphically illustrates a simplified block diagram of an exemplary temperature-adaptive rechargeable battery system in accordance with various embodiments.

FIG. 4 illustrates a flowchart of an exemplary operation for selecting temperature dependent C rates in accordance with various embodiments. The disclosure is not limited to this operational description.

FIG. 5 illustrates a flowchart of an exemplary operation for reducing the exposure time of the rechargeable battery to effectively slow the degradation of the rechargeable battery in accordance with various embodiments

The disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### C Rate of a Rechargeable Battery

Before describing exemplary temperature-adaptive battery charging systems, the charging and/or discharging of a rechargeable battery is to be generally described. The chemical energy of the rechargeable battery can be restored by applying electrical energy, such as a charging current, to the rechargeable battery. This electrical energy supplies electrons to the anode and removes electrons from the cathode that forces their respective chemical reactions into reverse to replenish the stored chemical energy within the rechargeable battery. Often times, the charging of the rechargeable battery can be expressed as a C rate to normalize the charging of the rechargeable battery to its battery capacity. Typically, a C rate represents a measure of the rate at which the rechargeable battery can be charged relative to its maximum capacity. A rechargeable battery being charged at a 1C rate indicates that the electrical energy being applied to the rechargeable battery should charge the rechargeable battery in one (1) hour. For example, with a rechargeable battery having a capacity of one (1) ampere hour (Ah), this rechargeable battery will be fully charged in one (1) hour in accordance with a charging current of 1 ampere (A). Similarly, a rechargeable battery being charged at a C/40 rate indicates that the electrical energy being applied to the rechargeable battery should charge the rechargeable battery in 40 hours. For example, with a rechargeable battery having a capacity of one (1) ampere hour (A-h), this rechargeable battery will be fully charged in forty (40) hours in accordance with a charging current of 25 milliamperes (mAs). Likewise, a rechargeable battery being charged at a C/20 rate and a C/15 rate indicates that the electrical energy being applied to the rechargeable battery should charge the rechargeable battery in 20 hours and 15 hours, respectively.

### Overview

Often times, the rechargeable battery degrades as it is being repetitively charged over and over. For example, a high-end lithium-polymer battery can lose twenty (20) percent of its capacity after one thousand (1000) charge cycles. A speed at which the rechargeable battery degrades can be related to its exposure time. The rechargeable battery degrades faster when its exposure time is longer and/or degrades slower when its exposure time is shorter. In some situations, as the rechargeable battery degrades, material can be removed from the anode causing the anode to generate less electrons and/or material can be removed from the cathode causing the cathode to receive less electrons. Moreover, as the rechargeable battery degrades, the cathode can become unstable, oxidized, and/or more reactive which can lead to increased side reactions, electrolyte oxidation, and/or cathode mutation forming electrochemically inactive spinels. These above degradations in the rechargeable battery are often irreversible which can result in the rechargeable battery having less capacity over time. As to be described in further detail below, the exemplary temperature-adaptive battery charging systems can adaptively discontinue, or disable, charging of the rechargeable battery in accordance with various C rates to reduce the exposure time of the rechargeable battery to effectively slow the degradation of the rechargeable battery.

As to be described in further detail below, the exemplary temperature-adaptive battery charging systems can discontinue, or disable, charging of the rechargeable battery in accordance with various C rates, such as the C/40 rate, the C/20 rate, and/or the C/15 rate to provide some examples, in response to the temperature of the rechargeable battery. In some embodiments, the exemplary temperature-adaptive battery charging systems can discontinue, or disable, charging of the rechargeable battery in accordance a first C rate, such as the C/40 rate to provide an example, when the temperature of the rechargeable battery is within a first temperature range. From the example above with the rechargeable battery having a capacity of one (1) ampere hour (A-h), the C/40 rate can specify that the charging of the rechargeable battery is to discontinued, or disabled, when the charging current is at 25 milliamperes (mAs) when the rechargeable battery is within the first temperature range. As to be described in further detail below, the exemplary temperature-adaptive battery charging systems can dynamically adapt the discontinuing, or cutting off, of the charging of the rechargeable battery in response to the temperature of the rechargeable battery increasing and/or decreasing as the rechargeable battery being charged. In some embodiments, the exemplary temperature-adaptive battery charging systems can dynamically adapt the discontinuing, or cutting off, of the charging of the rechargeable battery from being in accordance with the first C rate to be in accordance with a second C rate, such as the C/20 rate or the C/15 rate to provide some examples, when the temperature of the rechargeable battery increases from the first temperature range to a second temperature range. From the example above with the rechargeable battery having a capacity of one (1) ampere hour (A-h), the C/20 rate of the second temperature adaptive charging protocol can specify that the charging of the rechargeable battery is to discontinued, or disabled, when the charging current is at 50 milliamperes (mAs) when the rechargeable battery is within the second temperature range.

### Exemplary Portable Electronic Device

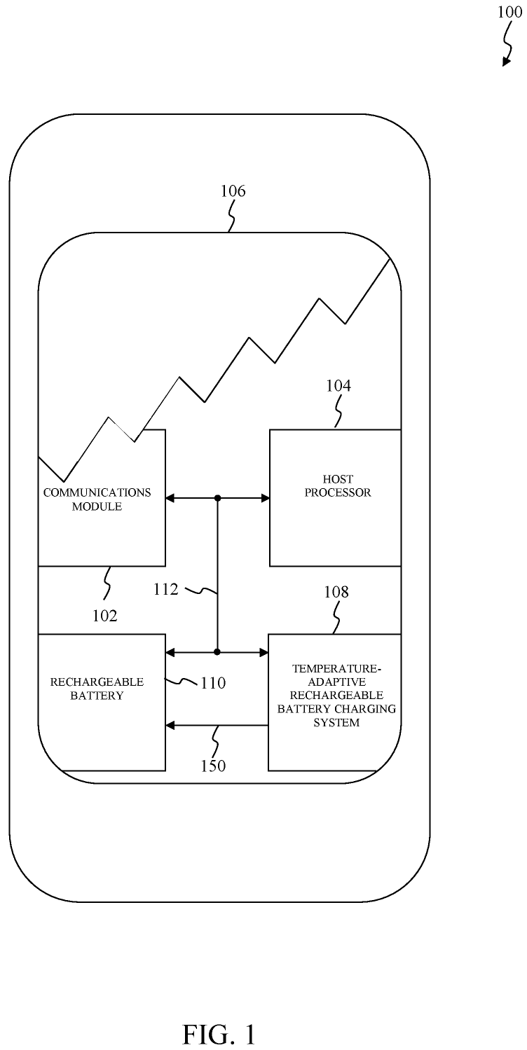

FIG. 1 graphically illustrates a simplified block diagram of a portable electronic device in accordance with various embodiments. In the exemplary embodiment illustrated in FIG. 1, a portable electronic device 100 communicates information, such as audio data, video data, image data, command data, control data and/or other data to provide some examples, between a near-end user and a far-end user over various wired and/or wireless communication networks. In some embodiments, the portable electronic device 100 can include mobile telephony devices, such as mobile phones; mobile computing devices; mobile internet devices, such as tablet computers and/or laptop computers; video game consoles; portable media players; wearable electronic devices, such as smartwatches, and/or other suitable mechanical, electrical, or electromechanical devices that include rechargeable battery that will be recognized by those skilled in the relevant art(s) without departing from the spirit and scope of the present disclosure. In the exemplary embodiment illustrated in FIG. 1, the portable electronic device 100 can include a rechargeable battery that can be charged in accordance with a temperature adaptive charging protocol that can be thermally adapted in response to the temperature of the rechargeable battery. As to be described in further detail below, the temperature adaptive charging protocol can include a series of charging operations to charge the rechargeable battery in accordance with one or more C rates, such as a 1.3C rate, a 1.0C rate, a 0.7C rate, a 0.4C, the C/15 rate, the C/20 rate, and/or the C/40 rate to provide some examples. As to be described in further detail below, the portable electronic device 100 can select from among the one or more C rates of the temperature adaptive charging protocol in response to the temperature of the rechargeable battery to reduce the exposure time of the rechargeable battery to effectively slow the degradation of the rechargeable battery. In the exemplary embodiment illustrated in FIG. 1, the portable electronic device 100 can include a communication module 102, a host processor 104, a touch screen display 106, a temperature-adaptive rechargeable battery system 108, a rechargeable battery 110, and a communication interface 112.

The communication module 102 can include a Bluetooth module, a Global Position System (GPS) module, a cellular module, a wireless local area network (WLAN) module, a near field communication (NFC) module, a radio frequency identification (RFID) module and/or a wireless power transfer (WPT) module. The Bluetooth module, the cellular module, the WLAN module, the NFC module, and the RFID module provide wireless communication between the portable electronic device 100 and other Bluetooth, other cellular, other WLAN, other NFC, and other RFID capable communication devices, respectively, in accordance with various communication standards or protocols. These various communication standards or protocols can include various cellular communication standards such as a third Generation Partnership Project (3GPP) Long Term Evolution (LTE) communications standard, a fourth generation (4G) mobile communications standard, or a third generation (3G) mobile communications standard, various networking protocols such a Worldwide Interoperability for Microwave Access (WiMAX) communications standard or a Wi-Fi communications standard, various NFC/RFID communications protocols such as ISO 1422, ISO/IEC 14443, ISO/IEC 15693, ISO/IEC 18000, or FeliCa to provide some examples. The GPS module receives various signals from various satellites to determine location information for the portable electronic device 100. The WPT module supports wireless transmission of power between the portable electronic device 100 and another WPT capable communication device.

The host processor 104 controls overall operation and/or configuration of the portable electronic device 100. In some embodiments, the host processor 104 represents a central processing unit (CPU) that can receive commands, perform calculations, and/or provide various electronic signals throughout the portable electronic device 100. Typically, the host processor 104 can perform arithmetic, logic, controlling, and input/output (I/O) operations specified by instructions in one or more computer programs. In these embodiments, the one or more computer programs can include one or more applications such as Short Message Service (SMS) for text messaging, electronic mailing, and/or audio and/or video recording to provide some examples, and/or software applications such as a calendar and/or a phone book to provide some examples. The host processor 104 can include an arithmetic logic unit (ALU) to perform arithmetic and logic operations, one or more processor registers to supply operands to the ALU and store results of ALU operations, and one or more control units that executes the instructions in the computer program by directing the coordinated operations of the ALU, registers and other components of the portable electronic device 100. In some embodiments, the host processor 104 can include a Graphics Processing Unit (GPU), an image processing unit (IPU), and/or other dedicated processing units that will be recognized by those skilled in the relevant art(s) without departing from the spirit and scope of the present disclosure.

The touch screen display 106 represents a graphical display device that allows a user to interact with the portable electronic device 100. In some embodiments, the user can provide various inputs for the one or more computer programs executing on the host processor 104 and/or control overall operation and/or configuration of the portable electronic device 100 through simple or multi-touch gestures by touching the touch screen display 106 with a special stylus and/or one or more fingers. In some embodiments, the touch screen display 106 can display various graphical images generated by the one or more computer programs executing on the host processor 104 to the user. The touch screen display 106 can be implemented as a resistive touchscreen, a surface acoustic wave touchscreen, and/or a capacitive touchscreen to provide some examples. In some embodiments, the touch screen display 106 can include a liquid-crystal display (LCD) or an organic light-emitting diode (OLED) display to provide some examples.

The temperature-adaptive rechargeable battery system 108 provides a charging current 150 to charge the rechargeable battery 110 in accordance with a temperature adaptive charging protocol that can be thermally adapted in response to the temperature of the rechargeable battery 110. In some embodiments, the temperature adaptive charging protocol can include one or more constant current (CC) charging operations, one or more constant voltage (CV) charging operations, and/or one or more constant voltage/constant current (CVCC) charging operations to charge the rechargeable battery 110 in accordance with multiple temperature independent C rates, such as a 1.3C rate, a 1.0C rate, a 0.7C rate, and/or a 0.4C to provide some examples, and/or multiple temperature dependent C rates, such as the C/15 rate, the C/20 rate, and/or the C/40 rate as described above to provide some examples. However, those skilled in the relevant art(s) will recognize that other temperature independent C rates and/or temperature dependent C rates are possible without departing from the spirit and scope of the present disclosure. The one or more constant current (CC) charging operations can represent various charging operations performed by the temperature-adaptive rechargeable battery system 108 that effectively vary the voltage at the rechargeable battery 110 to maintain a constant, or near constant, current flow from the charging current 150 to the rechargeable battery 110. The one or more constant voltage (CV) charging operations can represent various charging operations performed by the temperature-adaptive rechargeable battery system 108 that effectively vary the current flow from the charging current 150 to the rechargeable battery 110 to effectively maintain a constant, or near constant, voltage at the rechargeable battery 110. The one or more constant voltage/constant current (CVCC) charging operations can represent various combinations of the one or more constant current (CC) charging operations and/or the one or more constant voltage (CV) charging operations.

In the exemplary embodiment illustrated in FIG. 1, the temperature-adaptive rechargeable battery system 108 performs the one or more constant current (CC) charging operations, the one or more constant voltage (CV) charging operations, the and/or one or more constant voltage/constant current (CVCC) charging operations in accordance with the multiple temperature independent C rates specified by the temperature adaptive charging protocol to charge the rechargeable battery 110 to a pre-determined battery voltage, for example, a maximum battery voltage. Thereafter, the temperature-adaptive rechargeable battery system 108 can reduce the charging current 150 in accordance with a temperature dependent C rate that is selected from among the multiple temperature dependent C rates based upon the temperature of the rechargeable battery 110. In some embodiments, the host processor 104 and/or the temperature-adaptive rechargeable battery system 108 can select a first temperature dependent C rate, such as the C/40 rate to provide an example, from among the multiple temperature dependent C rates in response to the temperature of the rechargeable battery 110 being within a first temperature range, for example, less than thirty (30) degrees Celsius. In these embodiments, the host processor 104 and/or the temperature-adaptive rechargeable battery system 108 can select a second temperature dependent C rate, such as the C/20 rate to provide an example, from among the multiple temperature dependent C rates in response to the temperature of the rechargeable battery 110 being within a second temperature range, for example, between thirty (30) degrees Celsius and thirty-seven (37) degrees Celsius. In these embodiments, the host processor 104 and/or the temperature-adaptive rechargeable battery system 108 can select a third temperature dependent C rate, such as the C/15 rate to provide an example, from among the multiple temperature dependent C rates in response to the temperature of the rechargeable battery 110 being within a third temperature range, for example, greater than thirty-seven (37) degrees Celsius. Alternatively, or in addition to, in some embodiments, the temperature-adaptive rechargeable battery system 108 can determine the temperature dependent C rate from:

$$\frac{C}{{x}^{′}}$$

wherein C represents the 1.0C rate and x represents a mathematical function, for example, f(T), having the temperature (T) of rechargeable battery 110 as the argument of the mathematical function. In some embodiments, the host processor 104 and/or the temperature-adaptive rechargeable battery system 108 can discontinue, or disable, the charging of the rechargeable battery 110 in response to the charging current 150 being at, or to, the selected temperature dependent C rate to reduce the exposure time of the rechargeable battery 110 to effectively slow the degradation of the rechargeable battery 110

In the exemplary embodiment illustrated in FIG. 1, the rechargeable battery 110 stores energy in a chemical form and can convert the stored chemical energy into electrical energy via electrochemical reactions. In some embodiments, the rechargeable battery 110 can include one or more rechargeable battery cells that can be implemented using one or more nickel-cadmium (NiCd) rechargeable battery cells, one or more nickel-iron (NiFe) rechargeable battery cells, one or more nickel-metal hydride (NiMH) rechargeable battery cells, one or more lithium-ion rechargeable battery cells, and/or lithium-ion polymer (LiPo) battery cells, and/or any other suitable battery chemistry, or chemistries, that will be recognized by those skilled in the relevant art(s) without departing from the spirit and scope of the present disclosure. In some embodiments, the rechargeable battery 110 can be implemented as a smart battery that provides one or more parameters, attributes, and/or characteristics, such as voltage, temperature, and/or time under charge to provide some examples, to the host processor 104 and/or the temperature-adaptive rechargeable battery system 108. In these embodiments, the rechargeable battery 110 can include a battery management system (BMS) to provide the one or more parameters, attributes, and/or characteristics of the rechargeable battery 110 to the host processor 104 and/or the temperature-adaptive rechargeable battery system 108 via the communication interface 112, which is to be described in further detail below. During operation of the portable electronic device 100, a first chemical reaction within one or more first electrodes, called the anodes, of the one or more rechargeable battery cells generates electrons and a second chemical reaction within one or more second electrodes, called the cathodes, of the one or more rechargeable battery cells receives these electrons. This flow of electrons from the anodes to the cathodes discharges electrical energy from the one or more rechargeable battery cells for operation of the portable electronic device 100. The chemical energy of one or more rechargeable battery cells can be restored by applying the charging current 150 in accordance with the series of charging operations as described above. The charging current 150 supplies electrons to the anodes and removes electrons from the cathodes that forces their respective chemical reactions into reverse to replenish the stored chemical energy within the one or more rechargeable battery cells.

The communication interface 112 routes various communications between the communications module 102, the host processor 104, and the proximity screen display interface 108. These communications can include various digital signals, such as one or more commands and/or data to provide some examples, various analog signals, such as direct current (DC) currents and/or voltages to provide some examples, or any combination thereof. The communication interface 112 can be implemented as a series of wired and/or wireless interconnections between the communications module 102, the host processor 104, and the proximity screen display interface 108. The interconnections of the communication interface 112 can be arranged to form a parallel interface to route communications between the communications module 102, the host processor 104, and the proximity screen display interface 108 in parallel, a serial interface to route communications between the communications module 102, the host processor 104, and the proximity screen display interface 108, or any combination thereof.

### Exemplary Temperature Adaptive Charging Protocols

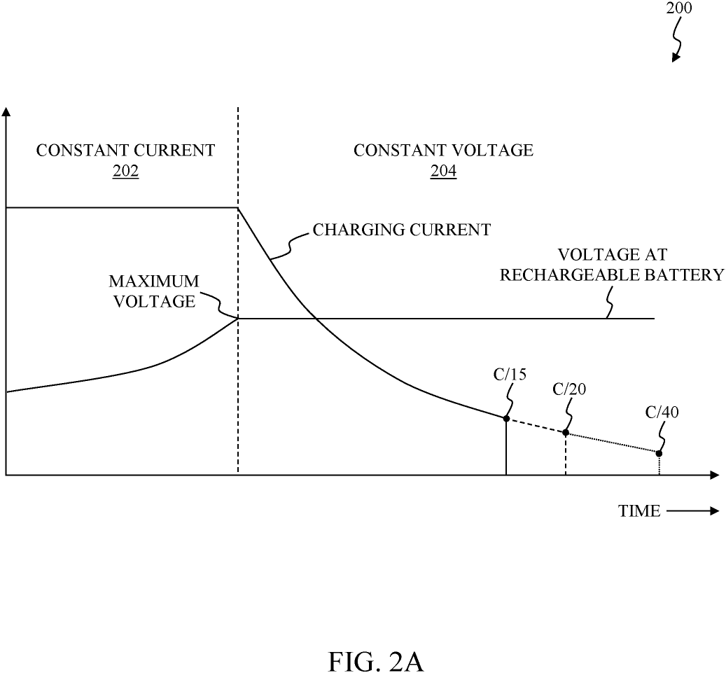

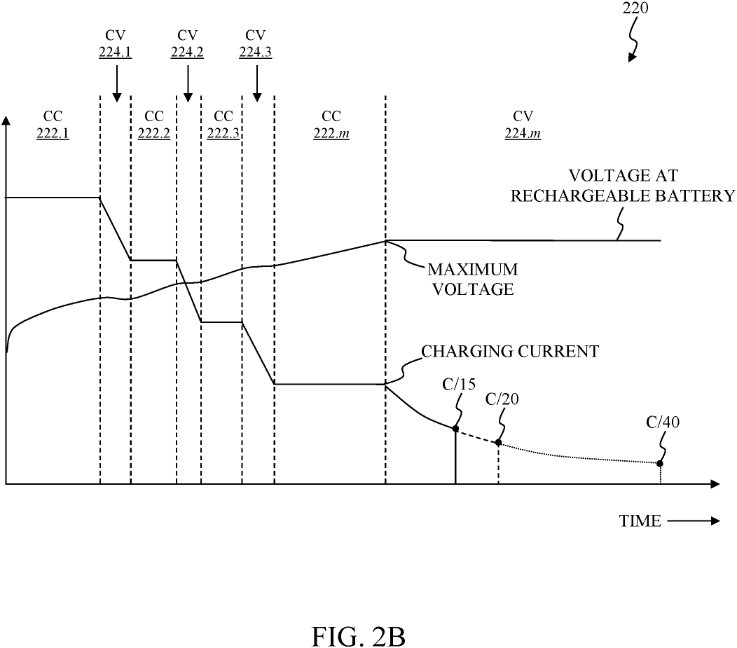

FIG. 2A and FIG. 2B graphically illustrate exemplary temperature adaptive charging protocols to charge an exemplary rechargeable battery in accordance with various embodiments. As described above in FIG. 1, a rechargeable battery, such as the rechargeable battery 110 to provide an example, can be charged in accordance with a temperature adaptive charging protocol that can be thermally adapted in response to the temperature of the rechargeable battery. As illustrated in FIG. 2A and FIG. 2B, a temperature adaptive charging protocol 200 and a temperature adaptive charging protocol 220, respectively, can include one or more constant current (CC) charging operations, one or more constant voltage (CV) charging operations, and/or one or more constant voltage/constant current (CVCC) charging operations to charge the rechargeable battery in accordance with one or more temperature independent C rates, such as a 1.3C rate, a 1.0C rate, a 0.7C rate, and/or a 0.4C to provide some examples, and/or one or more temperature dependent C rates, such as the C/15 rate, the C/20 rate, and/or the C/40 rate as described above to provide some examples. The temperature adaptive charging protocol 200, as illustrated FIG. 2A, represents a simple temperature adaptive charging protocol having a single constant voltage/constant current (CVCC) charging operation. However, those skilled in the relevant art(s) will recognize that more complex temperature adaptive charging protocols are possible having multiple constant current (CC) charging operations, multiple constant voltage (CV) charging operations, and/or multiple constant voltage/constant current (CVCC) charging operations, such as the temperature adaptive charging protocol 220 as illustrated FIG. 2B, without departing from the spirit and scope of the present disclosure. It should be noted that the temperature adaptive charging protocol 200 and the temperature adaptive charging protocol 220 are not illustrated to scale in FIG. 2A. and FIG. 2B, respectively.

In the exemplary embodiment illustrated in FIG. 2A, the temperature adaptive charging protocol 200 represents a constant voltage/constant current (CVCC) charging operation having a constant current (CC) charging operation 202 and a constant voltage (CV) charging operation 204. As illustrated in FIG. 2A, a charging current can be provided to the rechargeable battery to charge the rechargeable battery during the constant current (CC) charging operation 202 to charge the rechargeable battery to a pre-determined battery voltage, for example, a maximum battery voltage. In some embodiments, the charging current can be configured according to the one or more temperature independent C rates, such as a 1.3C rate, a 1.0C rate, a 0.7C rate, and/or a 0.4C to provide some examples. Upon reaching the pre-determined battery voltage, the temperature adaptive charging protocol 200 switches from the constant current (CC) charging operation 202 to the constant voltage (CV) charging operation 204. As illustrated in FIG. 2A, the constant voltage (CV) charging operation 204 effectively reduces the charging current in accordance with a temperature dependent C rate that is selected from among the one or more temperature dependent C rates, such as the C/15 rate, the C/20 rate, and/or the C/40 rate as described above to provide some examples based, upon the temperature of the rechargeable battery.

In some embodiments, the C/40 rate can be selected in response to the temperature of the rechargeable battery being less than thirty (30) degrees Celsius, the C/20 rate can be selected in response to the temperature of the rechargeable battery between thirty (30) degrees Celsius and thirty-seven (37) degrees Celsius, and/or the C/15 rate can be selected in response to the temperature of the rechargeable battery being greater than thirty-seven (37) degrees Celsius. As illustrated in FIG. 2A, the temperature adaptive charging protocol 200 can discontinue, or disable, the charging of the rechargeable battery in response to the charging current being at, or to, the selected temperature dependent C rate to reduce the exposure time of the rechargeable battery to effectively slow the degradation of the rechargeable battery. For example, upon selection of the C/40 rate, the temperature adaptive charging protocol 200 can discontinue, or disable, the charging of the rechargeable battery in response to the charging current being at, or to, the C/40 rate as illustrated by the dotted line in FIG. 2A. In this example, upon selection of the C/20 rate, the temperature adaptive charging protocol 200 can discontinue, or disable, the charging of the rechargeable battery in response to the charging current being at, or to, the C/20 rate as illustrated by the dashed line in FIG. 2A. In this example, upon selection of the C/15 rate, the temperature adaptive charging protocol 200 can discontinue, or disable, the charging of the rechargeable battery in response to the charging current being at, or to, the C/150 rate as illustrated by the solid line in FIG. 2A.

In the exemplary embodiment illustrated in FIG. 2B, the temperature adaptive charging protocol 220 represents multiple constant voltage/constant current (CVCC) charging operations having constant current (CC) charging operations 222.1 through 222.m and constant voltage (CV) charging operations 224.1 through 224.m. As illustrated in FIG. 2B, a charging current can be provided to the rechargeable battery to charge the rechargeable battery during the constant current (CC) charging operations 222.1 through 222.m to charge the rechargeable battery to pre-determined battery voltages. In some embodiments, the charging current can be configured according to the one or more temperature independent C rates, such as a 1.3C rate, a 1.0C rate, a 0.7C rate, and/or a 0.4C to provide some examples. Upon reaching the pre-determined battery voltages, the temperature adaptive charging protocol 220 switches from the constant current (CC) charging operations 222.1 through 222.m to corresponding constant voltage (CV) charging operations from among the constant voltage (CV) charging operations 224.1 through 224.m. As illustrated in FIG. 2B, the constant voltage (CV) charging operations 224.1 through 224.3 effectively reduce the charging current in accordance with the one or more temperature independent C rates, such as a 1.3C rate, a 1.0C rate, a 0.7C rate, and/or a 0.4C to provide some examples, and the constant voltage (CV) charging operation 224.m effectively reduces the charging current in accordance with a temperature dependent C rate that is selected from among the one or more temperature dependent C rates, such as the C/15 rate, the C/20 rate, and/or the C/40 rate as described above to provide some examples based, upon the temperature of the rechargeable battery as described above. In some embodiments, the temperature adaptive charging protocol 200 can discontinue, or disable, the charging of the rechargeable battery in response to the charging current being at, or to, the selected temperature dependent C rate to reduce the exposure time of the rechargeable battery to effectively slow the degradation of the rechargeable battery in a substantially similar manner as described above in FIG. 2A.

### Exemplary Temperature-Adaptive Rechargeable Battery System

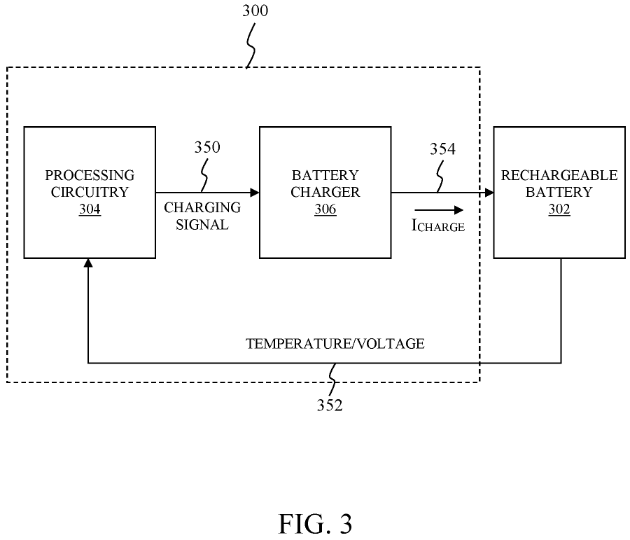

FIG. 3 graphically illustrates a simplified block diagram of an exemplary temperature-adaptive rechargeable battery system in accordance with various embodiments. In the exemplary embodiment illustrated in FIG. 3, a temperature-adaptive rechargeable battery system 300 can provide a charging current to charge a rechargeable battery 302 in accordance with a temperature adaptive charging protocol that can be thermally adapted in response to the temperature of the rechargeable battery 302. As illustrated in FIG. 3, the temperature-adaptive rechargeable battery system 300 can include processing circuitry 304 and a battery charger 306. The rechargeable battery system 300 and the rechargeable battery 302 can represent exemplary embodiments of the rechargeable battery system 108 and the rechargeable battery 108, respectively, as described above in FIG. 1.

The processing circuitry 304 controls overall operation and/or configuration of the temperature-adaptive rechargeable battery system 300 in charging the rechargeable battery 302 in accordance with the temperature adaptive charging protocol. Although the processing circuitry 304 is illustrated as being a standalone device, or a discrete device in FIG. 3, those skilled in the relevant art(s) will recognize that the processing circuitry 304 can be incorporated within or coupled to one or more other electrical, mechanical, and/or electro-mechanical devices, or host devices, such as the host processor 104 as described above in FIG. 1, without departing from the spirit and scope of the present disclosure. Moreover, those skilled in the relevant art(s) will recognize that some of the operations of the processing circuitry 304 can be performed by the battery charger 306 without departing from the spirit and scope of the present disclosure. For the purposes of this discussion, the term “processing circuitry” shall be understood to be one or more: circuit(s), processor(s), or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to embodiments described herein. Alternatively, the processor can access an internal and/or external memory to retrieve instructions stored in the memory, which when executed by the processor, perform the corresponding function(s) associated with the processor. As described above, the temperature adaptive charging protocol can include one or more constant current (CC) charging operations, one or more constant voltage (CV) charging operations, and/or one or more constant voltage/constant current (CVCC) charging operations to charge the rechargeable battery in accordance with multiple temperature independent C rates, such as a 1.3C rate, a 1.0C rate, a 0.7C rate, and/or a 0.4C to provide some examples, and/or multiple temperature dependent C rates, such as the C/15 rate, the C/20 rate, and/or the C/40 rate as described above to provide some examples. Exemplary embodiments of this temperature adaptive charging protocol were described above in FIG. 2A and FIG. 2B.

In the exemplary embodiment illustrated in FIG. 3, the processing circuitry 304 provides a charging signal 350 to the battery charger 306 to charge the rechargeable battery 302 in accordance with the temperature adaptive charging protocol. In some embodiments, the charging signal 350 can indicate the one or more constant current (CC) charging operations, the one or more constant voltage (CV) charging operations, and/or the one or more constant voltage/constant current (CVCC) charging operations to charge the rechargeable battery to be used by the battery charger 306 to charge the rechargeable battery 302. In these embodiments, the processing circuitry 304 can monitor one or more parameters, attributes, and/or characteristics of the rechargeable battery 302, such as a temperature of the rechargeable battery 302, a voltage at the rechargeable battery 302, collectively referred to as temperature/voltage 352 in FIG. 3, and/or a charging current 354 to provide some examples. In these embodiments, the processing circuitry 304 can monitor the one or more parameters, attributes, and/or characteristics of the rechargeable battery 302 before the rechargeable battery 302 is about to be charged, during the charging of the rechargeable battery 302, and/or after the rechargeable battery 302 has been charged. In some embodiments, the processing circuitry 304 can provide the charging signal 350 to the battery charger 306 to cause the battery charger 306 to switch from among the one or more constant current (CC) charging operations, the one or more constant voltage (CV) charging operations, and/or the one or more constant voltage/constant current (CVCC) charging operations in response to the one or more parameters, attributes, and/or characteristics of the rechargeable battery 302.

For example, the processing circuitry 304 can provide the charging signal 350 to the battery charger 306 to cause the battery charger 306 to operate in a constant current (CC) charging operation, such as the constant current (CC) charging operation 202 as described above in FIG. 2A and/or one of the constant current (CC) charging operations 222.1 through 222.m as described above in FIG. 2B to provide some examples. In this example, the processing circuitry 304 can monitor the voltage at the rechargeable battery 302 as the battery charger 306 is charging the rechargeable battery 302. Thereafter, the processing circuitry 304 can provide the charging signal 350 to the battery charger 306 to cause the battery charger 306 to switch from the constant current (CC) charging operation to a constant voltage (CV) charging operation, such as the constant current (CV) charging operation 204 as described above in FIG. 2A and/or one of the constant voltage (CV) charging operations 224.1 through 224.m as described above in FIG. 2B to provide some examples, in response to the voltage at the battery reaching a pre-determined battery voltage.

In some embodiments, the charging signal 350 can alternatively, or additionally, indicate one or more temperature independent C rates, such as the 1.3C rate, the 1.0C rate, the 0.7C rate, and/or the 0.4C to provide some examples, and/or one or more temperature dependent C rates, such as the C/15 rate, the C/20 rate, and/or the C/40 rate to provide some examples, to be utilized by the battery charger 306 to charge the rechargeable battery 302. In the exemplary embodiment illustrated in FIG. 3, the processing circuitry 304 can select a temperature dependent C rate from among multiple temperature dependent C rates in response to the temperature of the rechargeable battery 302. In some embodiments, the processing circuitry 304 can select a first temperature dependent C rate, such as the C/40 rate to provide an example, from among the multiple temperature dependent C rates in response to the temperature of the rechargeable battery 302 being within a first temperature range, for example, less than thirty (30) degrees Celsius. In these embodiments, the processing circuitry 304 can select a second temperature dependent C rate, such as the C/20 rate to provide an example, from among the multiple temperature dependent C rates in response to the temperature of the rechargeable battery 302 being within a second temperature range, for example, between thirty (30) degrees Celsius and thirty-seven (37) degrees Celsius. In these embodiments, the processing circuitry 304 can select a third temperature dependent C rate, such as the C/15 rate to provide an example, from among the multiple temperature dependent C rates in response to the temperature of the rechargeable battery 302 being within a third temperature range, for example, greater than thirty-seven (37) degrees Celsius. Alternatively, or in addition to, in some embodiments, the processing circuitry 304 can determine the temperature dependent C rate from:

$$\frac{C}{{x}^{′}}$$

wherein C represents the 1.0C rate and x represents a mathematical function, for example, f(T), having the temperature (T) of rechargeable battery 304 as the argument of the mathematical function. In some embodiments, the processing circuitry 304 can provide the charging signal 350 to the battery charger 306 to cause the battery charger 306 to discontinue, or disable, charging of the rechargeable battery in response to the charging current being at, or to, the selected temperature dependent C rate to reduce the exposure time of the rechargeable battery to effectively slow the degradation of the rechargeable battery.

In the exemplary embodiment illustrated in FIG. 3, the battery charger 350 provides the charging current 354 to the rechargeable battery 302 to charge the rechargeable battery 302 in accordance with the temperature adaptive charging protocol. In some embodiments, the battery charger 350 can be implemented as a simple charger, a fast charger, a three-stage charger, an induction-powered charger, a smart charger, a motion-powered charger, a pulse charger, and/or any other suitable mechanical, electrical, or electromechanical device that is capable of charging the rechargeable battery 302 that will be apparent to those skilled in the relevant art(s) without departing from the spirit and scope of the present disclosure.

In some embodiments, the battery charger 350 configures the charging current 354 in accordance with the one or more temperature independent C rates and/or the one or more temperature dependent C rates provided by the processing circuitry 304 to the battery charger 350 using the charging signal 350. For example, the battery charger 306 can configure the charging current 354 to be a constant, or near constant, current in accordance with the one or more temperature independent C rates and/or the one or more temperature dependent C rates indicated by the charging signal 350 and/or can adjust, for example, reduce, the charging current 354 in accordance with the one or more temperature independent C rates and/or the one or more temperature dependent C rates indicated by the charging signal 350 to implement the one or more constant current (CC) charging operations, the one or more constant voltage (CV) charging operations, and/or the one or more constant voltage/constant current (CVCC) charging operations provided by the processing circuitry 304 to the battery charger 350 using the charging signal 350.

In some embodiments, the battery charger 350 can control the charging current 354 to implement the one or more constant current (CC) charging operations, the one or more constant voltage (CV) charging operations, and/or the one or more constant voltage/constant current (CVCC) charging operations provided by the processing circuitry 304 to the battery charger 350 using the charging signal 350. For example, the battery charger 306 can configure the charging current 354 to be a constant, or near constant, current and/or can control the constant, or near constant, current to implement a constant current (CC) charging operation, such as the constant current (CC) charging operation 202 as described above in FIG. 2A and/or one of the constant current (CC) charging operations 222.1 through 222.m as described above in FIG. 2B to provide some examples. In this example, the battery charger 306 can switch from the constant current (CC) charging operation to a constant voltage (CV) charging operation, such as the constant current (CV) charging operation 204 as described above in FIG. 2A and/or one of the constant voltage (CV) charging operations 224.1 through 224.m as described above in FIG. 2B to provide some examples, in response to the charging signal 350 indicating that the voltage at the rechargeable battery 302 has reached a pre-determined battery voltage. In this example, the battery charger 306 can reduce the charging current 354 while maintaining the voltage at the rechargeable battery 302 constant, or near constant, to implement the constant current (CV) charging operation.

The rechargeable battery 304 stores energy in a chemical form and can convert the stored chemical energy into electrical energy via electrochemical reactions. In some embodiments, the rechargeable battery 304 can include one or more rechargeable battery cells that can be implemented using one or more nickel-cadmium (NiCd) rechargeable battery cells, one or more nickel-iron (NiFe) rechargeable battery cells, one or more nickel-metal hydride (NiMH) rechargeable battery cells, one or more lithium-ion rechargeable battery cells, and/or lithium-ion polymer (LiPo) battery cells, and/or any other suitable battery chemistry, or chemistries, that will be recognized by those skilled in the relevant art(s) without departing from the spirit and scope of the present disclosure. In some embodiments, the rechargeable battery 304 can be implemented as a smart battery that provides one or more parameters, attributes, and/or characteristics, such as the temperature/voltage 352, to the processing circuitry 304. In these embodiments, the rechargeable battery 304 can include a battery management system (BMS) to provide the one or more parameters, attributes, and/or characteristics of the rechargeable battery 304 to the processing circuitry 304. In some embodiments, the chemical energy of one or more rechargeable battery cells can be restored by applying the charging current 354 in accordance with the series of charging operations as described above. The charging current 354 supplies electrons to the anodes and removes electrons from the cathodes that forces their respective chemical reactions into reverse to replenish the stored chemical energy within the one or more rechargeable battery cells.

### Exemplary Routines to Reduce Exposure Time of a Rechargeable Battery

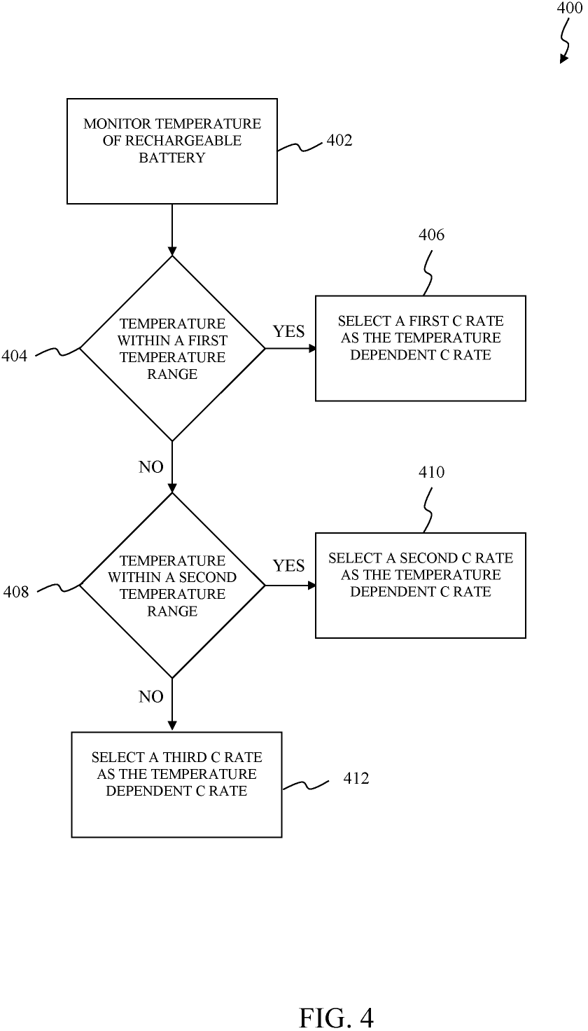

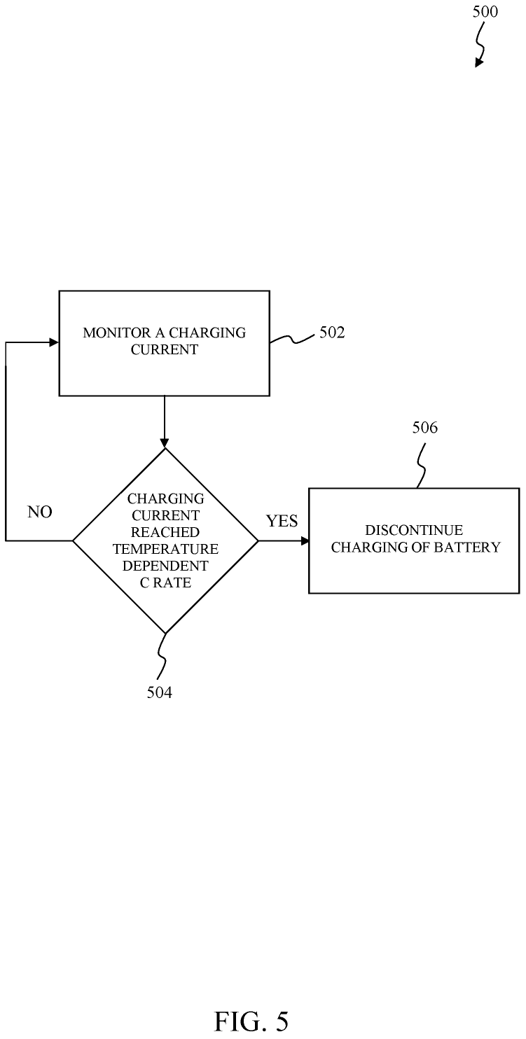

FIG. 4 illustrates a flowchart of an exemplary operation for selecting temperature dependent C rates in accordance with various embodiments. The disclosure is not limited to this operational description. Rather, it will be apparent to ordinary persons skilled in the relevant art(s) that other operational control flows are within the scope and spirit of the present disclosure. The following discussion describes an exemplary operational control flow 400 to select a temperature dependent C rate from among multiple temperature dependent C rates, such as the C/15 rate, the C/20 rate, and/or the C/40 rate to provide some examples, in response to a temperature of a rechargeable battery, such as the rechargeable battery 110 as described above in FIG. 1 and/or the rechargeable battery 302 as described above in FIG. 3. In some embodiments, the temperature dependent C rate can be utilized by a battery charger, such as the temperature-adaptive rechargeable battery system 108 as described above in FIG. 1 and/or the battery charger 306 as described above in FIG. 3, to reduce the exposure time of the rechargeable battery to effectively slow the degradation of the rechargeable battery as to be described in further detail below in FIG. 5. In the exemplary embodiment illustrated in FIG. 4, the exemplary operational control flow 400 can be performed by processing circuitry, such as the host processor 104 as described above in FIG. 1 and/or the processing circuitry 304 as described above in FIG. 3.

At operation 402, the operational control flow 400 monitors the temperature of the rechargeable battery. In some embodiments, the processing circuitry 304 can monitor the operational control flow 400 before the rechargeable battery is about to be charged, during the charging of the rechargeable battery, and/or after the rechargeable battery has been charged.

At operation 404, the operational control flow 400 determines whether the temperature of the rechargeable battery is within a first temperature range, for example, less than thirty (30) degrees Celsius. The operational control flow 400 proceeds to operation 406 when the temperature of the rechargeable battery is within the first temperature range or to operation 408 when the temperature of the rechargeable battery is not within the first temperature range.

At operation 406, the operational control flow 400 selects a first temperature dependent C rate, such as the C/40 rate to provide an example, from among the multiple temperature dependent C rates in response to the temperature of the rechargeable battery being within the first temperature range.

At operation 408, the operational control flow 400 determines whether the temperature of the rechargeable battery is within a second temperature range, for example, between thirty (30) degrees Celsius and thirty-seven (37) degrees Celsius. The operational control flow 400 proceeds to operation 410 when the temperature of the rechargeable battery is within the second temperature range or to operation 412 when the temperature of the rechargeable battery is not within the second temperature range.

At operation 410, the operational control flow 400 selects a second temperature dependent C rate, such as the C/20 rate to provide an example, from among the multiple temperature dependent C rates in response to the temperature of the rechargeable battery being within the second temperature range.

At operation 412, the operational control flow 400 selects a third temperature dependent C rate, such as the C/15 rate to provide an example, from among the multiple temperature dependent C rates. At operation 412, the temperature of the rechargeable battery is within a third temperature range, for example, greater than thirty-seven (37) degrees Celsius.

FIG. 5 illustrates a flowchart of an exemplary operation for reducing the exposure time of the rechargeable battery to effectively slow the degradation of the rechargeable battery in accordance with various embodiments. The disclosure is not limited to this operational description. Rather, it will be apparent to ordinary persons skilled in the relevant art(s) that other operational control flows are within the scope and spirit of the present disclosure. The following discussion describes an exemplary operational control flow 500 to reduce the exposure time of a rechargeable battery, such as the rechargeable battery 110 as described above in FIG. 1 and/or the rechargeable battery 302 as described above in FIG. 3, to effectively slow the degradation of the rechargeable battery. In the exemplary embodiment illustrated in FIG. 5, the exemplary operational control flow 500 can be performed by processing circuitry, such as the host processor 104 as described above in FIG. 1 and/or the processing circuitry 304 as described above in FIG. 3.

At operation 502, the operational control flow 500 monitors a charging current, such as the charging current 150 as described above in FIG. 1 and/or the charging current 354 as described above in FIG. 3.

At operation 504, the operational control flow 500 determines whether the charging current has reached a selected temperature dependent C rate. In some embodiments, the temperature dependent C rate can be selected from among multiple temperature dependent C rates in a substantially similar manner as described above. Alternatively, or in addition to, in some embodiments, the temperature dependent C rate can be determined from:

$$\frac{C}{{x}^{′}}$$

wherein C represents the 1.0C rate and x represents a mathematical function, for example, f(T), having the temperature (T) of rechargeable battery as the argument of the mathematical function. The operation control flow 500 proceeds to operation 506 when the charging current is at, or to, the selected temperature dependent C rate. Otherwise, the operational control flow 500 reverts to operation 502 to continue to monitor the charging current.

At operation 506, the operational control flow 500 can discontinue, or disable, charging of the rechargeable battery in response to the charging current being at, or to, the selected temperature dependent C rate to reduce the exposure time of the rechargeable battery to effectively slow the degradation of the rechargeable battery.

### Conclusion

Embodiments of the disclosure can be implemented in hardware, firmware, software application, or any combination thereof. Embodiments of the disclosure can also be implemented as instructions stored on one or more computer-readable mediums, which can be read and executed by one or more processors. A computer-readable medium can include any mechanism for storing or transmitting information in a form readable by a computer (e.g., a computing circuitry). For example, a computer-readable medium can include non-transitory computer-readable mediums such as read only memory (ROM); random access memory (RAM); magnetic disk storage media; optical storage media; flash memory devices; and others. As another example, the computer-readable medium can include transitory computer-readable medium such as electrical, optical, acoustical, or other forms of propagated signals (e.g., carrier waves, infrared signals, digital signals, etc.). Further, firmware, software application, routines, instructions have been described as performing certain actions. However, it should be appreciated that such descriptions are merely for convenience and that such actions in fact result from computing devices, processors, controllers, or other devices executing the firmware, software application, routines, instructions, etc.

It is to be appreciated that the Detailed Description section, and not the Summary and Abstract sections, is intended to be used to interpret the claims. The Summary and Abstract sections may set forth one or more but not all exemplary embodiments of the disclosure as contemplated by the inventor(s), and thus, are not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the disclosure should not be limited by any of the above-described exemplary embodiments, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A temperature-adaptive rechargeable battery system, comprising:
a battery charger configured to provide a charging current to charge a rechargeable battery; and
processing circuitry configured to:
monitor a temperature of the rechargeable battery,
select a temperature dependent C rate for charging the rechargeable battery based upon the temperature of the rechargeable battery, and
cause the battery charger to disable the charging current in response to the charging current reaching the selected temperature dependent C rate.

2. The temperature-adaptive rechargeable battery system of claim 1, wherein the processing circuitry is configured to:
select a first temperature dependent C rate from among a plurality of temperature dependent C rates to be the temperature dependent C rate in response to the temperature of the rechargeable battery being within a first temperature range;
select a second temperature dependent C rate from among the plurality of temperature dependent C rates to be the temperature dependent C rate in response to the temperature of the rechargeable battery being within a second temperature range; and
select a third temperature dependent C rate from among the plurality of temperature dependent C rates to be the temperature dependent C rate in response to the temperature of the rechargeable battery being within a third temperature range.

3. The temperature-adaptive rechargeable battery system of claim 2, wherein the first temperature dependent C rate comprises a C/40 rate,
wherein the second temperature dependent C rate comprises a C/20 rate, and
wherein the third temperature dependent C rate comprises a C/15 rate.

4. The temperature-adaptive rechargeable battery system of claim 2, wherein the first temperature range comprises temperatures less than thirty (30) degrees Celsius,
wherein the second temperature range comprises temperatures between thirty (30) degrees Celsius and thirty-seven (37) degrees Celsius, and
wherein the third temperature range comprises temperatures greater than thirty-seven (37) degrees Celsius.

5. The temperature-adaptive rechargeable battery system of claim 1, wherein the battery charger is configured to:
vary a voltage at the rechargeable battery to maintain the charging current as a constant current in a constant current (CC) charging operation; and
vary the charging current based on the selected temperature dependent C rate to maintain the voltage at the rechargeable battery in a constant voltage (CV) charging operation.

6. The temperature-adaptive rechargeable battery system of claim 5, wherein the processing circuitry is further configured to:
monitor the voltage at the rechargeable battery; and
cause the battery charger to switch from the CC charging operation to the CV charging operation in response to the voltage reaching a pre-determined battery voltage.

7. The temperature-adaptive rechargeable battery system of claim 1, wherein the processing circuitry is configured to determine the temperature dependent C rate from: c
$$\frac{c}{x} ,$$
wherein C represents a 1.0C rate and x represents a mathematical function having the temperature of rechargeable battery as an argument of the mathematical function.

8. A method of operating a rechargeable battery, the method comprising:
monitoring, by a processor circuitry, a temperature of a rechargeable battery as the rechargeable battery is being charged by a charging current;
selecting, by the processor circuitry, a temperature dependent C rate from among a plurality of temperature dependent C rates in response to the temperature of the rechargeable battery; and
disabling, by the processor circuitry, charging of the rechargeable battery in response to the charging current reaching the selected temperature dependent C rate.

9. The method of claim 8, wherein the selecting comprises:
selecting, by the processor circuitry, a first temperature dependent C rate from among the plurality of temperature dependent C rates to be the temperature dependent C rate in response to temperature of the rechargeable battery being within a first temperature range;
selecting, by the processor circuitry, a second temperature dependent C rate from among the plurality of temperature dependent C rates to be the temperature dependent C rate in response to temperature of the rechargeable battery being within a second temperature range; and
selecting, by the processor circuitry, a third temperature dependent C rate from among the plurality of temperature dependent C rates to be the temperature dependent C rate in response to temperature of the rechargeable battery being within a third temperature range.

10. The method of claim 9, wherein the first temperature dependent C rate comprises a C/40 rate,
wherein the second temperature dependent C rate comprises a C/20 rate, and
wherein the third temperature dependent C rate comprises a C/15 rate.

11. The method of claim 9, wherein the first temperature range comprises temperatures less than thirty (30) degrees Celsius,
wherein the second temperature range comprises temperatures between thirty (30) degrees Celsius and thirty-seven (37) degrees Celsius, and
wherein the third temperature range comprises temperatures greater than thirty-seven (37) degrees Celsius.

12. The method of claim 8, further comprising:
causing, by the processor circuitry, a voltage at the rechargeable battery to be varied to maintain the charging current as a constant current in a constant current (CC) charging operation; and
causing, by the processor circuitry, the charging current to be varied toward the selected temperature dependent C rate to maintain the voltage at the rechargeable battery in a constant voltage (CV) charging operation.

13. The method of claim 12, further comprising:
monitoring, by the processor circuitry, the voltage at the rechargeable battery; and
switching, by the processor circuitry, from the CC charging operation to the CV charging operation in response to the voltage reaching a pre-determined battery voltage.

14. The method of claim 13, wherein the pre-determined battery voltage comprises:
a maximum battery voltage.

15. A portable electronic device, comprising:
a temperature-adaptive rechargeable battery system configured to provide a charging current to charge a rechargeable battery; and
a host processor configured to:
monitor a temperature of the rechargeable battery,
select a temperature dependent C rate in response to the temperature of the rechargeable battery, and
cause the temperature-adaptive rechargeable battery system to disable the charging current in response to the charging current reaching the selected temperature dependent C rate.

16. The portable electronic device of claim 15, wherein the host processor is configured to:
select a first temperature dependent C rate from among a plurality of temperature dependent C rates to be the temperature dependent C rate in response to the temperature of the rechargeable battery being within a first temperature range;
select a second temperature dependent C rate from among the plurality of temperature dependent C rates to be the temperature dependent C rate in response to temperature of the rechargeable battery being within a second temperature range; and
select a third temperature dependent C rate from among the plurality of temperature dependent C rates to be the temperature dependent C rate in response to the temperature of the rechargeable battery being within a third temperature range.

17. The portable electronic device of claim 16, wherein the first temperature dependent C rate comprises a C/40 rate,
wherein the second temperature dependent C rate comprises a C/20 rate,
wherein the third temperature dependent C rate comprises a C/15 rate,
wherein the first temperature range comprises temperatures less than thirty (30) degrees Celsius,
wherein the second temperature range comprises temperatures between thirty (30) degrees Celsius and thirty-seven (37) degrees Celsius, and
wherein the third temperature range comprises temperatures greater than thirty-seven (37) degrees Celsius.

18. The portable electronic device of claim 15, wherein the host processor is configured to determine the temperature dependent C rate from:
$$\frac{c}{x} ,$$
wherein C represents a 1.0C rate and x represents a mathematical function having the temperature of rechargeable battery as an argument of the mathematical function.

19. The portable electronic device of claim 15, wherein the rechargeable temperature-adaptive rechargeable battery system is configured to:
vary a voltage at the rechargeable battery to maintain the charging current as a constant current in a constant current (CC) charging operation; and
vary the charging current toward the selected temperature dependent C rate to maintain the voltage at the rechargeable battery in a constant voltage (CV) charging operation.

20. The portable electronic device of claim 19, wherein the host processor is further configured to:
monitor the voltage at the rechargeable battery; and
cause the rechargeable temperature-adaptive rechargeable battery system to switch from the CC charging operation to the CV charging operation in response to the voltage reaching a pre -determined battery voltage.
